(19) United States
(12) Patent Application Publication
(10) Pub. No.: US 2007/0021917 A1
(43) Pub. Date: Jan. 25, 2007

(54) 3-structure of a whole integrin $g(a) v$g(b) extracellular region and uses therefor

(76) Inventors: M Amin Arnaout, Chesnut Hill, MA (US); Jian-Ping Xiong, Quincy, MA (US)

Correspondence Address: FISH & RICHARDSON PC, 225 FRANKLIN ST, BOSTON, MA, 02110, US

(21) Appl. No.: 10/475,905

(22) PCT Filed: Apr. 29, 2002
(86) PCT No.: PCT/US02/13525

§ 371 Date: Apr. 21, 2004

Related U.S. Application Data
(60) Provisional application No. 60/287,255, filed on Apr. 27, 2001.

(51) Int. Cl. G06F 19/00

(52) U.S. Cl. 702/19

(57) ABSTRACT

The invention features the structural coordinates of a portion of a αVβ3 integrin and the use of the coordinates in methods for identifying molecules which will bind to αVβ3 integrin and, preferably, modulate, e.g., increase or decrease, αVβ3 integrin-mediated adhesion and/or signalling. The identification methods generally involve computer-based structural modelling methods. Such methods can be combined with in vitro or in vivo screening methods to identify candidate therapeutic agent.

### BACKGROUND OR THE INVENTION

Integrins are a family of cell surface adhesion receptors that establish strong physical linkages between molecules outside of the cell and the actin cytoskeleton within (Burridge and Chrzanowska-Wodnicka (1996), Annu Rev Cell Dev Biol 12: 463-518; Hynes (1992), Cell 69(1): 11-25). Via these linkages, signals are transmitted across the membrane, in both directions. The signals are part of a complex network of events that control the adhesive properties of cells, the reorganization of the actin cytoskeleton, and the overall cell structure. Integrin-mediated signaling also influences cellular migration, survival, proliferation, and differentiation (Giancotti and Ruoslahti (1999), Science 285: 1028-32; Cary et al. (1999), Histol Histopathol 14(3): 1001-9). The fact that integrins are involved in so many critical cellular processes is reflected in the prominent role that they play during normal biological events such as embryonic development, wound healing, angiogenesis, bone remodeling, and the immune response, as well as aberrant events like tumor metastasis and auto-immune disease.

Integrins are believed to be the principal class of cell-surface receptors for the molecules that constitute the extracellular matrix (ECM), like laminin, collagen, and fibronectin (Hemler (1999) Integrins, in Guidebook to the Extracellular Matrix and Adhesion Proteins (Kreis and Vale, eds), Sambrook and Tooze Publishers, Oxford University Press; Hynes, supra). Integrins are also capable of interacting with other cell-surface adhesion receptors, including some members of the cell adhesion molecule (CAM) family. Overall, cell-cell adhesion involving integrins is less common than integrin-mediated cell-matrix adhesion, but it is frequently used by lymphocytes when they are responding to infection (Hemler, supra; Hynes, supra).

Integrins are heterodimers that are composed of alpha and beta subunits. At least eighteen genes encoding alpha integrin subunits and at least eight genes encoding beta integrin subunits have been identified in vertebrates. Since not all alpha subunits will dimerize with all beta subunits, however, only about twenty-four dimer pairs have been characterized (Hemler, supra). Each of these integrins binds to a specific set of ECM proteins, which is determined by both the interaction between the alpha and beta subunits and their combined interaction with the ligands (Plow et al. (2000), J Biol Chem 275(29): 21785-88; Hynes, supra).

αVβ3 integrin binds to many different extracellular proteins, including vitronectin, bone sialoprotein, and matrix metalloproteinase-2 (Plow et al., supra). Through its interactions with its extracellular ligands, and the resulting effects on cell differentiation, migration, and survival, αVβ3 mediates numerous physiologic processes such as angiogenesis and bone remodeling. (αVβ3 is the most abundant integrin displayed by osteoclasts, one of the cell types responsible for bone remodeling. Endothelial cells undergoing angiogenesis in wounds, tumors or inflammatory tissues express high levels of αVβ3. Some invasive tumors, such as metastatic melanoma, breast cancer, and late-stage glioblastoma also express αVβ3. Several studies indicate that αVβ3 over-expression on melanoma cells correlates with the invasive phase of human melanoma. Loss of the αV chain in an experimental cell line leads to a delay in tumor growth in vivo compared with the parental cells, and conversely, re-expression of the αV subunit in αV-defective cells restored tumorigenicity in vivo and survival in vitro. Ligation of αVβ3 integrin in malignant melanoma cells promotes cell survival in vitro, and blockade of αVβ3 triggers apoptosis of melanoma cells. Activation of αVβ3 is also a necessary feature of metastasis in breast cancer.

Occupation of αVβ3 integrin by ligands and its activation are important in the normal and pathologic function of αVβ3. Thus, compounds that bind to αVβ3 integrin, and thereby modulate, e.g., antagonize, its activity, could be effective drugs for the treatment of metastatic cancer and osteoporosis.

### SUMMARY OF THE INVENTION

The present invention is based, in part, on the determination of the structure of human αVβ3 integrin, which is a complex formed by the extracellular domain of the αV integrin subunit and the mature β3 integrin subunit. The coordinates for the αVβ3 integrin complex, consisting of amino acid residues 31 to 989 of the αv integrin subunit (SEQ ID NO:1) and 26 to 718 of the β3 integrin subunit (SEQ ID NO:2), are presented in Table 2 in standard Brookhaven database format.

In one aspect, the invention features a method for modeling the structure of other molecules that are homologous to αVβ33 integrin, e.g., other integrins. The method includes: generating alignments between the sequences of αV and another alpha integrin subunit of interest and between the sequences of β3 and another beta integrin subunit of interest; using the alignments to map the alpha and beta integrin subunits of interest onto the alpha-carbon backbone trace obtained from the αVβ3 integrin structure; and performing energy minimization on the alpha and beta integrin subunits of interest thus mapped, thereby producing a model for the most energetically favorable strucuture(s) of the integrin consisting of the alpha and beta integrin subunits of interest. In a preferred embodiment, the alpha and beta subunits of interest are experimentally known to associate with one another, e.g., αIIb and β3, αV and β1, α5 and β1, or αL and β2.

In another aspect, the invention features methods for modeling structural perturbations produced by mutations in an integrin subunit. The method is identical to the method described above, except that the integrin subunit sequences used contain at least one point mutation or a deletion of at least one amino acid. In a preferred embodiment, the mutations are present in an αV or β3 integrin subunit. In another embodiment, the mutations are present in a non-αV alpha integrin subunit or a non-β3 beta integrin subunit.

In another aspect, the invention features methods for identifying molecules which will bind to αVβ3 integrin and, preferably, modulate, e.g., increase or decrease, αVβ3 integrin-mediated adhesion and/or signaling. Preferred αVβ3 integrin-binding molecules identified using the method of the invention act as antagonists in one or more in vitro or in vivo assays of αVβ3 integrin-mediated adhesion and/or signaling. Preferred αVβ33 integrin-binding molecules lack peptide bonds. The preferred weight of αVβ3 integrin-binding molecules is less than about 5000, 4000, 3000, 2000, 1000, 750, 500, or even 400 Daltons.

In a preferred embodiment, the methods of the invention entail the identification of compounds that occupy a particular structural space. The methods rely upon the use of precise structural information derived from X-ray crystallographic studies of αVβ3 integrin. These crystallographic data permit the determination of the surface topology of the αVβ3 integrin extracellular domain. Molecules that are predicted to have a topology that includes a surface which is complemetary to a subset of the αVβ3 integrin extracellular domain surface, such that the interface between the molecule and a portion of the αVβ3 integrin extracellular domain is closely juxtaposed and the energy of association arising from the association, e.g., van der Waals forces and charge-charge interactions, is minimized, may be capable of binding to the αVβ3 integrin extracellular domain via, e.g., van der Waals forces and charge-charge interactions. In a preferred embodiment, the αVβ3 integrin extracellular domain surface with which molecules are predicted to form an interface includes a subset of the αVβ3 integrin extracellular domain surface defined by residues from both the αV and the β3 subunits. In another embodiment, the αVβ3 integrin extracellular domain surface with which molecules are predicted to form an interface includes a subset of the αVβ3 integrin extracellular domain surface defined exclusively by residues from the αV subunit, or a portion thereof. In yet another embodiment, the αVβ3 integrin extracellular domain surface with which molecules are predicted to form an interface includes a subset of the αVβ3 integrin extracellular domain surface defined exclusively by residues from the β3 subunit, or a portion thereof.

In yet another aspect, the invention features methods for identifying molecules which will bind to a non-αVβ3 integrin of interest and modulate adhesion and/or signaling mediated by the integrin. Preferred integrin-binding molecules identified using the method of the invention act as antagonists in one or more in vitro or in vivo assays of integrin-mediated adhesion and/or signaling which involve the integrin. Preferred integrin-binding molecules lack peptide bonds. The preferred molecular weight of αVβ3 integrin-binding molecules is less than about 5000, 4000, 3000, 2000, 1000, 750, 500, or even 400 Daltons.

In a preferred embodiment, the method is a combination of two of the methods described above: first, a structural model, based on the structure of αVβ3 integrin, is produced for a non-αVβ3 integrin; second, molecules are identified that are predicted to have a topology that includes a surface which is complementary to a subset of the extracellular domain surface of the structural model of the non-αVβ3 integrin, such that the interface between the molecule and the extracellular domain surface of the structural model of the non-αVβ3 is closely juxtaposed and the energy of association arising from the association, e.g., van der Waals forces and charge-charge interactions, is minimized. In a preferred embodiment, the extracellular domain surface of the model for the non-αVβ3 integrin, with which molecules are predicted to form an interface, includes a subset of the modeled extracellular domain surface defined by residues from both the alpha and beta subunit of said modeled integrin. In another embodiment, the extracellular domain surface of the model for the non-αVβ3 integrin, with which molecules are predicted to form an interface, includes a subset of the modeled extracellular domain surface defined exclusively by residues from the alpha subunit of said modeled integrin, or a portion thereof. In yet another embodiment, the extracellular domain surface of the model for the non-αVβ3 integrin, with which molecules are predicted to form an interface, includes a subset of the modeled extracellular domain surface defined exclusively by residues from the beta subunit of said modeled integrin, or a portion thereof.

In another aspect, the invention features a method for using the coordinates of the αVβ3 integrin structure of the invention to assist in the determination of the structure of the extracellular domain of αVβ3 integrin complexed with another molecule. The method involves producing a crystal of αVβ3 complexed with another molecule, gathering X-ray diffraction data from the crystal, and using the coordinates of the αVβ3 integrin structure of the present invention to solve, e.g., by molecular replacement, the structure of the complex. In a preferred embodiment, the molecule that is complexed with the extracellular domain of αVβ3 integrin modulates the activity, e.g., the cellular adhesion and/or signaling activity, of αVβ3 integrin. In an even more preferred embodiment, the molecule that is complexed with the extracellular domain of αVβ3 integrin antagonizes the activity, e.g., the cellular adhesion and/or signaling activity, of αVβ3 integrin.

The method used to produce crystals of αVβ3 for the purpose of X-ray diffraction and structural determination may be applicable to the crystallization of non-αVβ3 integrins. The method includes co-expressing an extracellular domain fragment of an alpha integrin subunit comprising a region equivalent to about amino acid residues 31 to 989 of the αV subunit along with an extracellular domain fragment of a beta integrin subunit comprising a region equivalent to about amino acid residues 26 to 718 of the β3 subunit in an eukayotic cell expression system, e.g., a baculovirus expression system, purifying the resulting integrin heterodimer, and forming crystals in an appropriate solution. In a preferred embodiment, the co-expressed alpha and beta subunit fragments are derived from integrin subunits experimentally known to associate with one another, e.g., αIIb and β3, αV and ⊖1, α5 and β1, α4 and β1, or αL and β2.

### FIGURES

FIG. 1 depicts the amino acid sequence of the αV subunit (SEQ ID NO: 1) of human αVβ33. Amino acids are represented by the standard single letter code; residues shown in bold, F31 and P989, represent the first and last residues of the crystallized αV subunit.

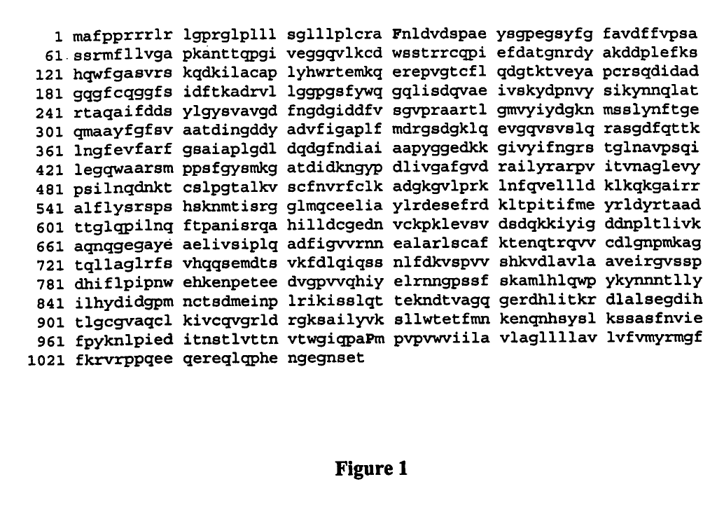

FIG. 2 depicts the amino acid sequence of the β3 subunit (SEQ ID NO:2) of human αVβ3. Amino acids are represented by the standard single letter code; residues shown in bold, G26 and D718, represent the first and last residues of the crystallized β3 subunit.

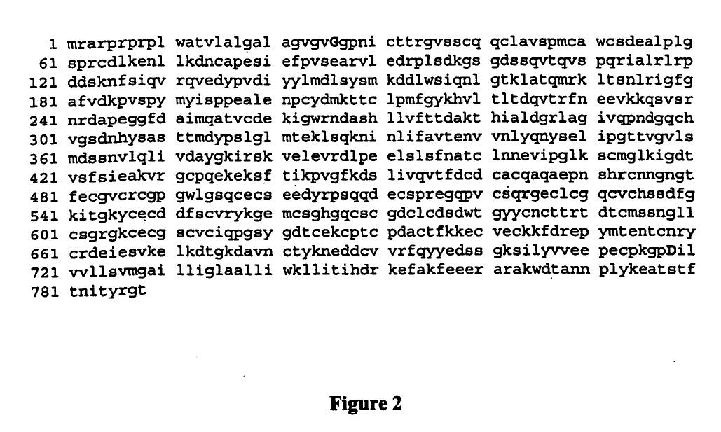

### DESCRIPTION OF THE PREFERRED EMBODIMENTS

As used herein, “point mutation” refers to a single amino acid substitution within the sequence of a protein. Specific mutants of a protein may include one or more point mutations, a deletion of at least one amino acid, or both.

The coordinates for the αVβ3 integrin complex, which includes amino acid residues 31 to 989 of the αV integrin subunit (amino acid residues 31 to 989 of SEQ ID NO: 1) and 26 to 718 of the β3 integrin subunit (amino acid residues 26 to 718 of SEQ ID NO:2), are presented in Table 2 in standard Brookhaven database format. The enclosed coordinates allow automatic placement of each of the αVβ3 residues in three dimensional (3-D) space, and thus are sufficient to generate the 3-D structure of this integrin. The structure determination and refinement statistics for the complex used to provide the coordinates in Table 2 are recited in Table 1.

The structure of αVβ3 integrin, which is in its active conformation, provides a framework for interpreting a vast body of biophysical, biochemical, biologic data on this integrin, including the organization and location of ligand-binding sequences, characteristics of alpha and beta subunit interactions, and conformational dynamics. The information that the structure provides makes it possible to model the structure of all integrins, including: α4⊕1, which has been implicated in multiple sclerosis; α5β1, which has been implicated in tumor angiogenesis; CD11a and CD11b integrins, which have been implicated in autoimmune diseases, psoriasis, and ischemia-reperfusion injury; and αIIbβ3, which is involved in thrombosis and is a target for thrombolytic therapy.

The methods of the invention employ computer-based methods for producing a structural model for a protein that is homologous to a protein for which a corresponding structure has been solved. Methods of computer-aided, homology-based structural prediction are well known to individuals skilled in the art. Such methods can be automated and performed via the internet using a desk-top PC. One example is the SWISS-MODEL structural prediction platform. Other more sophisticated algorithms, which involve less automation, could also be used in the methods of the invention.

The methods of the invention also employ computer-based methods for identifying compounds having a desired structure. These computer-based methods fall into two broad classes: database methods and de novo design methods. In database methods the compound of interest is compared to all compounds present in a database of chemical structures and compounds whose structure is in some way similar to the compound of interest are identified. The structures in the database are based on either experimental data, generated by NMR or x-ray crystallography, or modeled three-dimensional structures based on two-dimensional data. In de novo design methods models of compounds whose structure is in some way similar to the compound of interest are generated by a computer program using information derived from known structures, e.g., data generated by x-ray crystallography and/or theoretical rules. Such design methods can build a compound having a desired structure in either an atom-by-atom manner or by assembling small molecular fragments.

The success of both database and de novo methods in identifying compounds with activities similar to the compound of interest depends on the identification of the functionally relevant portion of the compound of interest. For drugs, the functionally relevant portion is referred to a pharmacophore. A pharmacophore then is an arrangement of structural features and functional groups important for biological activity, e.g, receptor binding.

Not all identified compounds having the desired pharmacophore will have the desired activity, e.g., modulation of integrin, e.g., αVβ3 integrin activity, e.g., cellular adhesion, migration, and/or signaling. The actual activity can be finally determined only by measuring the activity of the compound in relevant biological assays. However, the methods of the invention are extremely valuable because they can be used to greatly reduce the number of compounds which must be tested to identify an actual modulator, e.g., an agonist or antagonist, of a specific integrin, e.g., αVβ3 integrin.

Programs suitable for generating predicted three-dimensional structures from two-dimensional data include: Concord (Tripos Associated, St. Louis, Mo.), 3-D Builder (Chemical Design Ltd., Oxford, U.K.), Catalyst (Bio-CAD Corp., Mountain View, Calif.), Daylight (Abbott Laboratories, Abbott Park, Ill.).

Programs suitable for searching three-dimensional databases to identify molecules bearing a desired pharmacophore include: MACCS-3D and ISIS/3D (Molecular Design Ltd., San Leandro, Calif.), ChemDBS-3D (Chemical Design Ltd., Oxford, U.K.), Sybyl/3 DB Unity (Tripos Associates, St. Louis, Mo.). Programs suitable for pharmacophore selection and design include: DISCO (Abbott Laboratories, Abbott Park, Ill.), Catalyst (Bio-CAD Corp., Mountain View, Calif.), and ChemDBS-3D (Chemical Design Ltd., Oxford, U.K.).

Databases of chemical structures are available from Cambridge Crystallographic Data Centre (Cambridge, U.K.) and Chemical Abstracts Service (Columbus, Ohio).

De novo design programs include Ludi (Biosym Technologies Inc., San Diego, Calif.) and Aladdin (Daylight Chemical Information Systems, Irvine Calif.).

### EQUIVALENTS

Those skilled in the art will recognize, or be able to ascertain using no more than routine experimentation, many equivalents to the specific embodiments of the invention described herein.

TABLE 1
Structure Determination and Refinement

space group P3(2)21
unit cell

| data collection | native | Lu-derivative | Pt-derivative |
|---|---|---|---|
| wavelength(A) | 1.0332 | 1.3407 | 0.9840 |
| peak | 1.3412 | | |
| inflection | 1.2398 | | |
| remote | | | |

| | | | | | | | | | | |
|---|---|---|---|---|---|---|---|---|---|---|
| Resolution bins(A) | <6.2 | 4.96 | 4.33 | 3.94 | 3.65 | 3.44 | 3.27 | 3.12 | 3.00 | Overall |
| Rsym(%) | 6.2 | 7.5 | 8.4 | 10.2 | 17.3 | 22.7 | 34.6 | 49.7 | 69.4 | 10.9 |
| coverage(%) | 88.2 | 100.0 | 100.0 | 99.8 | 98.8 | 97.3 | 96.4 | 95.1 | 90.4 | 90.0 |
| Mean redundancy | 5.5 | 7.1 | 7.0 | 6.7 | 6.1 | 5.6 | 5.0 | 4.6 | 3.0 | 5.1 |
| I/Ü | | | | | | | | | | |
| No. of reflections | 6298 | 6855 | 6761 | 6749 | 6668 | 6501 | 6456 | 6358 | 6016 | 58662 |

| Heavy-atom derivatives | 5 mM LuCl₃ | 0.3 mM K₂Pt(NO₃)₄ |
|---|---|---|
| coverage(%) | 90.1 | 84.4 |
| inflection | 95.5 | |
| remote | 91.4 | |
| phasing power | | |
| centrics | 0.69 0.99 | 0.55 |
| acentrics | | |
| isomorphous | 0.79 1.20 | 0.58 |
| anomalous | 2.55 1.72 | 1.48 |
| Mean figure of merit | 0.776 | 0.786 |
| Rfree 36.8% | | |
| Rfactor 24.1 | | |

LENGTHY TABLE REFERENCED HERE
US20070021917A1-20070125-T00001
Please refer to the end of the specification for access instructions.

LENGTHY TABLE
The patent application contains a lengthy table section. A copy of the table is available in electronic form from the USPTO web site (http://seqdata.uspto.gov/?pageRequest=docDetail&DocID=US20070021917A1) An electronic copy of the table will also be available from the USPTO upon request and payment of the fee set forth in 37 CFR 1.19(b)(3).

1. A method for evaluating the potential of a chemical entity to associate with a molecule or molecular complex comprising a ligand binding pocket of an αVβ3 extracellular domain, the method comprising:
(i) employing computational means to perform a fitting operation between the chemical entity and a binding pocket defined by the structural coordinates described in Table 2; and
(ii) analyzing the results of said fitting operation to quantify the association between the chemical entity and the binding pocket.

2. A computer for producing a three-dimensional representation of a molecule or molecular complex, wherein said molecule or molecular complex comprises a binding pocket defined by the structural coordinates of Table 2 wherein said computer comprises:
(a) a machine-readable data storage medium comprising a data storage material encoded with machine-readable data, wherein said data comprises the structure coordinates of the amino acids of the αVβ3 extracellular domain contained in Table 2;
(b) a working memory for storing instructions for processing said machine-readable data;
(c) a central-processing unit coupled to said working memory and to said machine-readable data storage medium for processing said machine readable data into said three-dimensional representation; and
(d) a display coupled to said central-processing unit for displaying said three-dimensional representation.

3. A method for identifying a potential agonist or antagonist of a molecule comprising a αVβ3 receptor ligand binding pocket comprising the steps of:
(a) using the structure coordinates of Table 2 or coordinates having a root mean square deviation from the backbone atoms of amino acids of the αVβ3 extracellular domain coordinates in Table 2 of not more than 1.5 Angstroms, to generate a three-dimensional structure of molecule comprising a αVβ3 receptor ligand binding pocket;
(b) employing said three-dimensional structure to design or select said potential agonist or antagonist;
(c) providing said agonist or antagonist; and
(d) contacting said agonist or antagonist with said receptor to determine the ability of said potential agonist or antagonist to interact with said receptor.

4. The method of claim 3, wherein a three dimensional representation of the ligand binding pocket is generated by a computer program.

5. A method of identifying an compound capable of binding to an αVβ3 extracellular domain, the method comprising:
(a) introducing into a suitable computer program information defining at least a portion of the αVβ3 extracellular domain conformation defined by the structural coordinates of Table 2, wherein said program displays the three-dimensional structure thereof;
(b) creating a three dimensional structure of a test compound in said computer program;
(c) displaying and superimposing the model of said test compound on the model of said active site; and
(d) assessing whether said test compound model fits spatially into the ligand binding pocket.

6. A method of using the three-dimensional structure of αVβ3 integrin in a drug screening assay comprising:
(a) selecting a candidate drug by performing rational drug design with the structural coordinates in Table 2, wherein the selecting entail computer modeling of the three dimensional structure of αVβ3 integrin;
(b) contacting the selected candidate drug with a cell expressing αVβ3 integrin or a αVβ3 integrin extracellular domain in solution;
(c) detecting the binding of the candidate drug to the αVβ3 integrin expressed by the cell or the αVβ3 integrin extracellular domain in solution.

7. The method of claim 1 wherein the αVβ3 integrin comprises amino acid residues 31 to 989 of SEQ ID NO:1 and amino acid residues 26 to 718 of SEQ ID:2.
